(19) United States
(12) Patent Application Publication
(10) Pub. No.: US 2025/0077297 A1
(43) Pub. Date: Mar. 6, 2025

(54) LOAD BALANCING IN A DATA TRANSFORM ACCELERATOR

(71) Applicant: MAXLINEAR, INC., Carlsbad, CA (US)

(72) Inventors: Pinaki Shankar Chanda, San Diego, CA (US); Amandeep S. Garcha, Mission Viejo, CA (US); Sasidhar Paruchuri, San Diego, CA (US); Bin Wu, Hangzhou (CN); Michael Ray Ham, San Jose, CA (US)

(73) Assignee: MAXLINEAR, INC., Carlsbad, CA (US)

(21) Appl. No.: 18/817,217

(22) Filed: Aug. 27, 2024

Related U.S. Application Data
(60) Provisional application No. 63/580,083, filed on Sep. 1, 2023.

(51) Int. Cl. G06F 9/50

(52) U.S. Cl. CPC G06F 9/505; G06F 9/5038; G06F 9/5055

(57) ABSTRACT

A method includes obtaining multiple command requests, each including a command address. The method also includes performing a load balancing operation to select a first container of multiple containers to store a first command address. The method further includes storing the first command address in the first data container. The method also includes transmitting the first command address from the first data container to a data transform accelerator. The method further includes obtaining transformed data from the data transform accelerator.

### CROSS REFERENCE TO RELATED APPLICATIONS

This U.S. Patent Application claims priority to U.S. Provisional Patent Application No. 63/580,083, titled “LOAD BALANCING IN A DATA TRANSFORM ACCELERATOR,” and filed on Sep. 1, 2023, the disclosure of which is hereby incorporated by reference in its entirety.

### TECHNICAL FIELD

This disclosure generally relates to data transform acceleration, and more specifically, to load balancing in a data transform accelerator.

### BACKGROUND

Unless otherwise indicated herein, the materials described herein are not prior art to the claims in the present application and are not admitted to be prior art by inclusion in this section.

Data transform accelerators are co-processor devices that are used to accelerate data transform operations for various applications such as data analytics applications, big data applications, storage applications, cryptographic applications, and networking applications. For example, a data transform accelerator can be configured as a storage accelerator, a cryptographic accelerator, and/or an accelerator in a network interface card (NIC).

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining multiple command requests, where each command request may include a command address. The method may also include performing a load balancing operation to select a first container of multiple containers to store a first command address. The method may further include storing the first command address in the first data container. The method may also include transmitting the first command address from the first data container to a data transform accelerator. The method may further include obtaining transformed data from the data transform accelerator.

In another embodiment, a system may include a host device and at least one data transform accelerator. The host device may include one or more processors and host software. The host software may be operated by the one or more processors and may be operable to generate multiple command requests, each comprising multiple command addresses. The host software may also be operable to perform a load balancing operation to select a first container of multiple containers to store a first command address of the multiple command addresses. The host software may be further operable to direct the first command address to be stored in the first data container. The host software may also be operable to transmit the first command address from the first data container.

The at least one data transform accelerator may be operable to obtain the first command address transmitted from the first data container. The at least one data transform accelerator may further be operable to obtain a first command associated with the multiple command requests and first input data using the first command address. The at least one data transform accelerator may also be operable to perform a data transform operation to the first input data using the first command to generate transformed data. The at least one data transform accelerator may be further operable to transmit transformed data to the host device.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIGS. 1A and 1B illustrate block diagrams of example systems for load balancing in the systems including a data transform accelerator;

FIG. 2 illustrates a flowchart of an example method of load balancing in a system including a data transform accelerator;

FIG. 3 illustrates a flowchart of an example method of load balancing in a system including a data transform accelerator;

FIG. 4 illustrates a block diagram of an example system for load balancing in the system including a data transform accelerator and a virtual environment;

FIG. 5 illustrates a flowchart of an example method of load balancing in a system including a data transform accelerator;

FIG. 6 illustrates an example computing device; and

FIG. 7 illustrates equations used with load balancing in a system including a data transform accelerator.

### DETAILED DESCRIPTION

A data transform accelerator may be used as a coprocessor device in conjunction with a host device to accelerate data transform operations for various applications, such as data analytics, big data, storage, and/or networking applications. The data transform operations may include, but not be limited to, compression, decompression, encryption, decryption, authentication tag generation, authentication, data deduplication, Non-Volatile Memory express (NVMe) Protection Information (PI) generation, NVMe PI verification, and real-time verification.

A host device may be coupled with a data transform accelerator (e.g., a system) and host software may be operable to submit commands to the data transform accelerator. Compute resources on the data transform accelerator (e.g., data transform engines) may execute the commands and return the transformed data back to the host software on completion of the data transform operations. Alternatively, or additionally, the transform data may be directed a different device, such as, one or more network interface cards and/or storage arrays.

In some circumstances, throughput in the system may be limited and/or latency in the system may be increased as the commands sent from the host device to the data transform accelerator may use the resources included therein in a sub-optimal manner. Alternatively, or additionally, some existing approaches fail to implement a class of service associated with the execution of commands by the data transform accelerator, which may limit and/or reduce priority operations performed by the system, including the data transform accelerator.

At least some aspects of the present disclosure address these and other shortcomings of prior approaches by including load balancing operations performed by a portion of the system, such that commands may be transmitted from the host device to the data transform accelerator for data transform operations in a more optimized manner relative to the prior approaches. In some embodiments, the system as described in the present disclosure may experience improved throughput and/or reduced latency in the data transform operations. Further, in some aspects of the present disclosure, load balancing may be combined with one or more classes of service for command execution by the data transform accelerator. As such, the command submission process (and associated throughput thereof) by the host device may scale with a number of central processing units (CPUs) included in the host device up to a threshold bandwidth associated with the data transform accelerator. In such instances, contention of command submissions from the host device to the data transform accelerator may be reduced, latency of command execution may be reduced, throughput of the performance of the commands by the data transform accelerator may be increased, and/or resource sharing may be more equally distributed between data transform engines in a data transform accelerator and/or between multiple data transform accelerators in the system, all relative to the prior approaches.

In some instances, the host software may be operable to perform a load balancing operation for a selection of containers to store at least commands therein. The host software may be further operable to direct command addresses associated with the commands and that may be stored in the multiple containers, to the data transform accelerators. The data transform accelerators may be operable to obtain one or more commands from various containers and may be operable to process the input data using the command addresses associated with the commands. The data transform accelerators may perform a data transform operation to the input data and may transmit the transformed data to the host device.

In some instances, the containers may be grouped into one or more sets of containers to provide a class of service (or a quality of service) by the computing resources of at least one data transform accelerator (e.g., where one set of containers may be allocated for each class of service). A load balancing operation may be performed to select a first container in a particular set of containers belonging to a class of service to store a first command address. The selected class of service or the selected set of containers may be based on a class of service requirement associated with the first command and the load balance operation may be used to select a container belonging to set of containers. Alternatively, or additionally, the first command address may be transmitted from the first container belonging to the set of containers based on the class of service to the data transform accelerator. The data transform accelerator may be operable to obtain a first command associated with the first command address and first input data using the first command address from the first container.

In another embodiment, a system may include a host device operable to run one or more virtual machines. Containers that may be associated with at least one data transform accelerator may be grouped into one or more sets, and each set may be made available to the virtual machines using Input-Output (IO) virtualization. The software in each virtual machine may be operable to perform a load balancing operation to select a first container from the sets of containers assigned to the virtual machine to store a first command address. The software on the virtual machine may be operable to transmit the first command address from the first container to at least one data transform accelerator associated with the virtual machine. The data transform accelerator may be operable to obtain a first command and first input data using the first command address. The data transform accelerator may also be operable to perform a data transform operation to the first input data using the first command to generate transformed data. The data transform accelerator may further be operable to transmit transformed data to the virtual machine from which the command was submitted. The host software may also be operable to perform load balancing operation for selection of containers to store second and subsequent commands generated by the host software on each virtual machine. Alternatively, or additionally, in some instances, the system configured to operate the virtual machines may further be operable to provide a class of service associated with the commands, the command addresses, and/or the containers, as described herein.

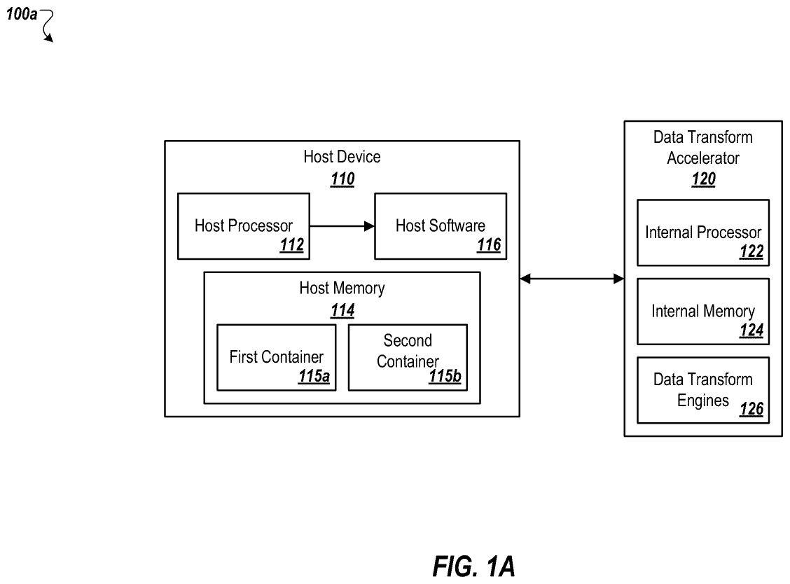

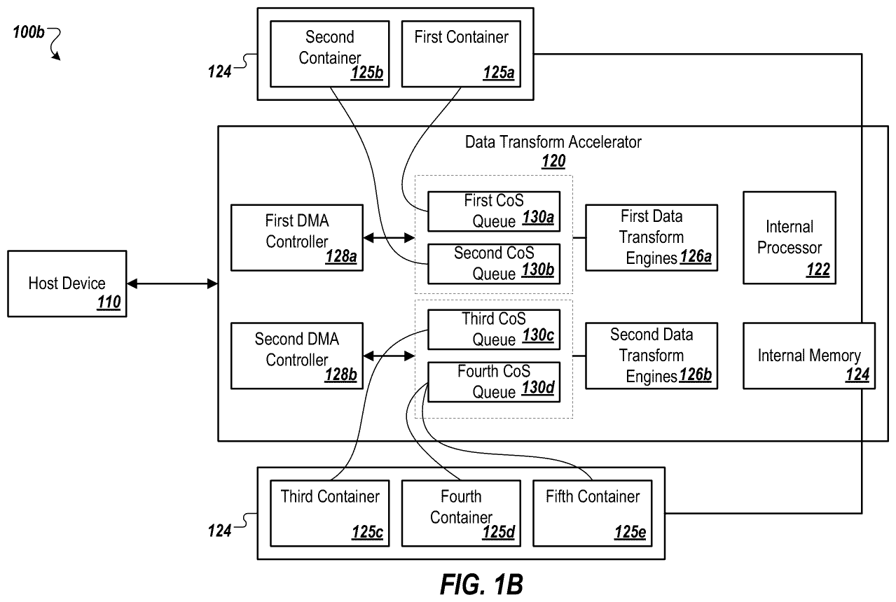

FIG. 1A illustrates a block diagram of an example system 100a for load balancing in the system 100a including a data transform accelerator 120, in accordance with at least one embodiment of the present disclosure. The system 100a may include a host device 110 and the data transform accelerator 120. The host device 110 may include a host processor 112, a host memory 114, and host software 116. The host memory 114 may include a first container 115a and a second container 115b, referred to collectively as the containers 115. The data transform accelerator 120 may include an internal processor 122, an internal memory 124, and data transform engines 126.

In some embodiments, the host device 110 (e.g., a host computer, a host server, etc.) may be in communication with the data transform accelerator 120 via a data communication interface (e.g., a Peripheral Component Interconnect express (PCIe) interface, a Universal Serial Bus (USB) interface, and/or other similar data communication interfaces). In some embodiments, upon a request by a user to transform source data that may be located in the host memory 114, the host software 116 (e.g., a software driver) on the host device 110 and operated by the host processor 112 may be directed to generate metadata (such as, but not limited to, data transform command pre-data including a command description, a list of descriptors dereferencing a different section of the metadata, and a list of descriptors dereferencing source data and destination data buffers, command pre-data including transform algorithms and associated parameters, source and action tokens describing different sections of the source data and transform operations to be applied to different sections, and/or additional command metadata) with respect to transforming the source data in the host memory 114. In some embodiments, the host software 116 may generate the metadata in the host memory 114 based on the source data that may be obtained from one or more sources. For example, the source data may be obtained from a storage associated with the host device 110 (e.g., a storage device), a buffer associated with the host device 110, a data stream from another device, etc. In these and other embodiments, obtaining the source data may include copying or moving the source data to the host memory 114.

In some embodiments, the host software 116 may direct the host processor 112 to generate the metadata associated with the source data. For example, the host software 116 may generate and/or submit one or more command requests to the host processor 112, which command requests may be associated with a data transform command and may include a command address. In some embodiments, the metadata may be stored in one or more input buffers. For example, in instances in which the metadata includes a data transform command that may contain a list of source descriptors, destination descriptors, command pre-data, source and action tokens, and additional command metadata, each of the individual components of the metadata may be stored in individual input buffers (e.g., the data transform command in a first input buffer, pre-data in the second input buffer, the source and action tokens in the third input buffer, and so forth).

In some embodiments, the input buffers associated with the metadata may be located in the host memory 114. Alternatively, or additionally, the input buffers associated with the metadata may be located in the internal memory 124. Alternatively, or additionally, the input buffers may be located in both the host memory 114 and the internal memory 124. For example, one or more input buffers associated with the metadata may be located in the host memory 114 and one or more input buffers associated with the metadata may be located in the internal memory 124. In these and other embodiments, the host processor 112 may direct the host software 116 to reserve one or more output buffers that may be used to store an output from the data transform accelerator 120. In some embodiments, the output buffers may be located in the host memory 114. In some embodiments, the output buffers may be located in the internal memory 124 of the data transform accelerator 120.

In instances in which the host processor 112 obtains command requests from the host software 116, including a request to generate the metadata and store the metadata in the internal memory 124 (e.g., in the input buffers located in the internal memory 124) and/or in the host memory 114, the host processor 112 may transmit commands to the data transform accelerator 120 (e.g., such as to a component of the data transform accelerator 120, such as the internal processor 122 and/or the data transform engines 126) via the data communication interface. For example, the internal memory 124 may be accessible and/or addressable by the host processor 112 via the data communication interface, and, in instances in which the data communication interface is PCIe, the internal memory 124 may be mapped to an address space of the host device 110 using a base address register associated with an endpoint of the PCIe (e.g., the data transform accelerator 120).

In some embodiments, the host software 116 may direct (e.g., via the host processor 112) the data transform accelerator 120 to process a data transform command. For example, the host software 116 may generate one or more command requests that may each include a command address and store the command addresses in one or more containers, such as the first container 115a and/or the second container 115b, as described herein. The data transform accelerator 120 may obtain the command addresses that may point to the data transform command.

In some embodiments, the command address and/or the data transform command may be located in the host memory 114, such as in the first container 115a and/or the second container 115b. Alternatively, or additionally, the command address may be programmed in the data transform accelerator 120, such as during an initialization of the data transform accelerator 120. In such instances, the data transform accelerator 120 (e.g., the internal processor 122 and/or the data transform engines 126) may obtain the command address and/or may access the data transform command in the host memory 114 using the data communication interface. Alternatively, or additionally, the command address and/or the data transform command may be located in one or more containers disposed the internal memory 124, and the command address may be obtained by the internal processor 122 and/or the data transform engines 126.

In some embodiments, the data transform command may be used by the data transform accelerator 120 to transform the source data based on data transform operations included in the data transform command. In some embodiments, the data transform operations may be performed, as directed by the data transform command, by the data transform engines 126. In some embodiments, the data transform engines 126 may be arranged according to the data transform command and/or the metadata (e.g., the metadata stored in the host memory 114 and/or stored in the internal memory 124), such that the data transform engines 126 form a data transform pipeline that may be configured to perform the data transform operations to the source data.

The data transform accelerator 120 and/or the components included therein (e.g., the internal processor 122, the internal memory 124, and/or the data transform engines 126) may be implemented using various systems and/or devices. For example, the data transform accelerator 120 may be implemented in hardware, software, firmware, a field-programmable gate array (FPGA), a graphics processing unit (GPU), and/or a combination of any of the above listed implementations.

The data transform accelerator 120 may be operable to perform data transform operations using one or more pipelines, the pipelines including a configuration of the data transform engines 126. The pipelines in the data transform accelerator 120 may be described as performing data transform operations in at least two directions, an encode direction and/or a decode direction. The encode direction data transform operations performed by a first pipeline in the data transform accelerator 120 may include one or more of NVMe PI verification on input data, compression, deduplication hash generation, padding, encryption, cryptographic hash generation, and NVMe PI generation on encoded data, and/or real-time verification on the encoded data. The decode direction data transform operations performed by a second pipeline in the data transform accelerator 120 may include one or more of decryption (e.g., with or without verification generated on the input data and/or the transformed data), depadding, decompression, deduplication hash generation on input data and/or transformed data (e.g., obtained from the input data), and/or NVMe PI verification on the encoded data and/or on the decoded data.

In these and other embodiments, host device 110 may use the data communication interface to transmit metadata to the data transform accelerator 120, which the internal processor 122 may direct to be stored in the internal memory 124 and the internal processor 122 may return the command address of the stored metadata to the host processor 112. Alternatively, or additionally, the host device 110 may use the data communication interface to transmit metadata directly to the internal memory 124 of the data transform accelerator 120.

As described, the host software 116 may submit one or more command requests to the host processor 112 and/or the data transform accelerator 120. In response to the command requests, a command structure may be generated that may be located in the host memory 114, the internal memory 124, and/or a combination of the host memory 114 and the internal memory 124. Subsequently, the command address associated with the command structure may be stored in the first container 115a, the second container 115b, and/or one or more containers disposed in the internal memory 124 (not illustrated in FIG. 1A, and will be discussed with respect to FIG. 1A as the containers disposed in the host memory 114, but it will be appreciated that the containers may be disposed in the internal memory 124). In these and other embodiments, the command address may be accessible by the data transform accelerator 120.

The containers 115 may be initialized at a time when the data transform accelerator 120 may be initialized. The containers 115 may be one or more command pointer rings and may be operable to store the command addresses that may be generated and/or requests by one or more command requests from the host software 116. In some instances, multiple threads on the CPUs of the host processor 112 and/or one or more applications of the host software 116 may submit command requests for storing command addresses and the containers 115 may be locked for mutual exclusion, which may reduce or remove a likelihood of race conditions associated with storing the command addresses in the first container 115a and/or the second container 115b.

The host device 110 may implement a load balancing operation to determine a particular container in which the command addresses may be stored. For example, the host processor 112 may obtain a first command request and an associated first command address, and the host software 116 may determine to store the first command address in the second container 115b in view of a load balancing method in the host device 110. In instances in which many command requests are obtained by the host device 110, the load balancing operation and the locking of the containers 115 may contribute to establishing parallelism in a command submission process to the data transform accelerator 120.

In some instances, multiple data transform accelerators may be in communication with the host device 110 and the load balancing operation performed by the host device 110 may be operable to load balance the command addresses between each of the containers that may be associated with the multiple data transform accelerators. For example, a first data transform accelerator may be associated with a first container and a second container and a second data transform accelerator may be associated with a third container and a fourth container. In the example arrangement, the host device 110 may obtain a command having a command address and the host device 110 may perform a load balancing operation to store the command address in one of the first container, the second container, the third container, or the fourth container, such that the host device 110 may perform a load balance operation across the multiple data transform accelerators (e.g., by performing a load balancing operation

Load balancing, as described herein, may contribute to improving and/or maximizing input/output operations per second (IOPS) between the host device 110 and the data transform accelerator 120. Alternatively, or additionally, the load balancing operations may contribute to scaling the commands submitted to the data transform accelerator 120 relative to the number of cores in the CPU(s) of the host processor 112, the number of threads running on the cores, and/or the number of applications in the host software 116. The scaling between the host device 110 and the data transform accelerator 120 may continue until a threshold bandwidth associated with the data transform accelerator 120 is satisfied. Alternatively, or additionally, the load balancing may reduce or remove contention of commands submitted to the data transform accelerator 120, reduce latency in the commands submitted to the data transform accelerator 120, increase the throughput of the commands submitted to the data transform accelerator 120, and/or distribute resources between multiple data transform accelerators (e.g., when more than the data transform accelerator 120 is included in the system 100a). The load balancing may be performed using one or more load balancing methods as further described herein.

In some embodiments, the host software 116 may include one or more components that may be used to facilitate load balancing between the host device 110 and the data transform accelerator 120. For example, the host software 116 may include a resource management module that may be operable to manage the resources associated with command submission and/or load balancing, a load balancing module that may be operable to determine a container to store a command address in, and/or a command submission module to submit the command address to the selected container that may be used by the data transform accelerator 120. In some instances, the containers 115 may be individually associated with particular data transform accelerators. For example, the first container 115a may be associated with the data transform accelerator 120 and the second container 115b may be associated with a second data transform accelerator 120.

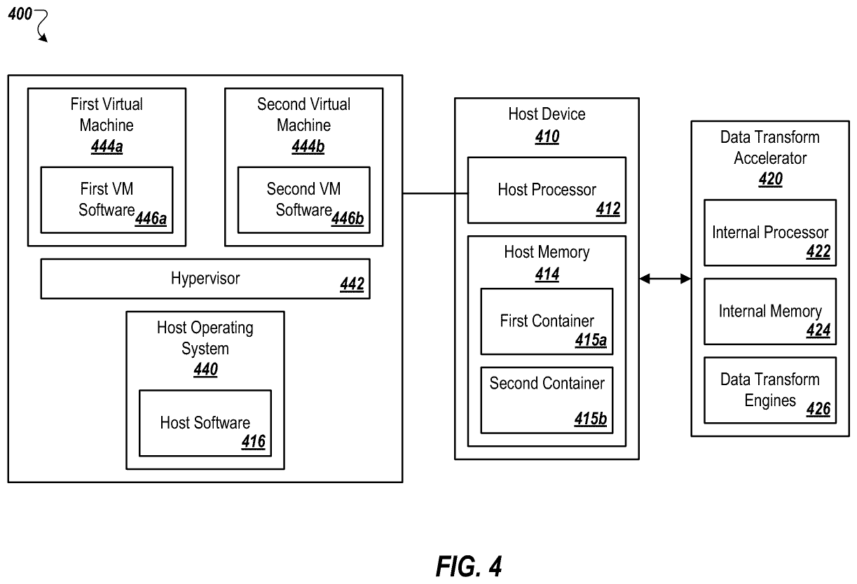

As described, one or more load balancing operations may be implemented in the host device 110 (e.g., performed by the load balancing module in the host software 116). The load balancing methods (e.g., the method of implementing load balancing) may include a round-robin method, a queue depth-based method, a CPU core ring-based method, a class of service method, and/or using an IO virtual environment (as described relative to FIG. 4 herein).

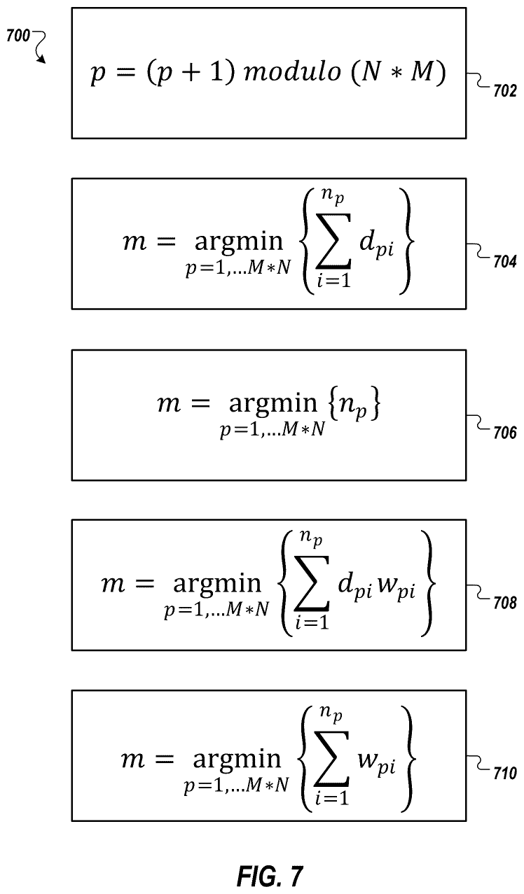

Load balancing using the round-robin method may include the load balancing module in the host software 116 obtaining an index associated with a most recent command submitted to the data transform accelerator 120 (and/or any other data transform accelerators that may be coupled with the host device 110). The index may be associated with any concurrently running thread in the host device 110. For example, in instances in which the index (e.g., the last container used for submission of a command) is p, the load balancing module chooses the next command pointer ring to submit this command using equation 702 of FIG. 7, where N is a number of containers associated with the data transform accelerator 120 and M is a number of data transform accelerators coupled to the host device 110. The x modulo y operation may output the remainder after dividing x by y (or, in other words, (p+1) divided by (N*M)). The index p may be updated for a next command submitted from any source (e.g., a current thread, a different thread, a different application, etc.) to the data transform accelerator 120. Alternatively, or additionally, the load balance operations may be operable to run in multiple instances, with one instance configured to run for each data transform accelerator device connected to the host device 110. In such instances, a next container may be selected locally among the containers 115 available to a particular data transform accelerator (e.g., the data transform accelerator 120), instead of considering all containers across all data transform accelerators attached to the host device 110.

As multiple threads in the host device 110 (e.g., threads associated with various cores in the host processor 112 and/or applications in the host software 116) may concurrently submit commands and/or access the index p stored in the host memory 114, resource locking by the resource management module in the host software 116 may be performed prior to updating the index p. Alternatively, or additionally, the index p may be operable as an atomic variable.

The selected container (e.g., the first container 115a) may be locked by the host software 116, such as by the command submission module, using a hardware lock, a software lock, and/or a hardware-software lock mechanism for mutual exclusion. Alternatively, or additionally, the containers 115 may implement a lock-free mechanism, such that the containers 115 may be accessible during the storing of the command address therein. Alternatively, or additionally, the containers 115 may be automatically configured or reconfigured between implementing a locking mechanism and implementing a lock-free mechanism. For example, in a first instance, the host software 116 may direct the containers 115 to implement a locking mechanism for mutual exclusion, as described herein. In a second instance, the host software 116 may direct the containers 115 to reconfigure to be a lock-free mechanism.

In some instances, the containers 115 may be implemented in software and may not include a hardware-assist lock-free mechanism. In such instances, the containers 115 may utilize a synchronization mechanism and/or software data structures that may not lock/unlock primitives. The containers 115 may facilitate multiple threads to concurrently store commands in the containers 115. For example, a read-copy-update mechanism may implement the described mechanism.

In another instance, the containers 115 may be implemented in software and may include a hardware-assist lock-free mechanism. In such instances, the containers 115 may be implemented with assistance from the data transform accelerator 120 where one or more of the containers 115 may be locked, the command submission module of the host software 116 may write a command address in a next available position of the selected container (e.g., either the selected container or a next container, as described), and the command submission module of the host software 116 may unlock the container. In instances in which the selected container is full, a next container (e.g., the second container 115b) may be selected. In such a lock-free mechanism, a register may be provided in the data transform accelerator 120 for each of the containers 115, and threads submitting commands to the containers 115 may write the address of the command in the register, as opposed to updating the read/write pointer of the containers 115. The data transform accelerator 120 may push the address of the command from the register and update a particular container with the address using a mechanism that enables such an update in an atomic fashion. Prior to writing to the register, the software may ensure that the write to the register may not cause a collision of the read/write pointer when the data transform accelerator 120 reads the value from the register and writes the command address in the particular container by updating the write pointer. The number of threads operating relative to the particular container may be known in advance in the host software 116. Before attempting to write in the register the address of the command, each thread may ensure that there are at least as many available entries in the particular container as the number of threads. Each time an address of a command is stored in the particular container, the data transform accelerator 120 may update the register to indicate to the host software 116 the amount of free space in the particular container, which may contribute to reducing collisions of operations based on the read/write pointer. In some instances, the threads may check the register (which may be read-only) before writing as opposed to computing an amount of free space in the particular container by reading the read/write pointer of the particular container.

The locking and unlocking of the container as described may be applicable to any of the load balancing methods described in the present disclosure.

Load balancing using the queue depth-based method may include the load balancing module in the host software 116 selecting a container which may have less pending operations than other containers once the command structure is generated (in response to obtaining a command request) in the host memory 114 and/or the internal memory 124. For example, in instances in which the first container 115a includes a first number of pending operations and the second container 115b includes a second number of pending operations that is less than the first number of pending operations, the second container 115b may be selected by the host software 116 to store a new command address using the queue depth-based load balancing method.

The amount of pending operations in a particular container may be a total amount of source data to be processed by the data transform accelerator 120 submitted from the particular container. Under such considerations, a container having the least amount of pending operations may be selected. The container of the containers 115 may be selected using equation 704 of FIG. 7, where dₚᵢ is the length of the source data in the i-th command in container p, nₚ is the total number of pending commands in container p, M is number of containers associated with one data transform accelerator, and N is the total number of data transform accelerators. In instances in which there are additional data transform accelerators and the additional data transform accelerators are individually associated with a different number of containers, the above selection process may consider all rings across all data transform accelerators. Alternatively, or additionally, the load balancing operations may be performed independently across different data transform accelerators, where each instance of the load balancing operations may consider containers available to a particular data transform accelerator (e.g., and may not consider containers available to other data transform accelerators).

In some embodiments, the N data transform accelerators may be the same or similar to one another. For example, each of the N data transform accelerators may be individually associated with an equal number of containers. Alternatively, or additionally, the N data transform accelerators may differ from one another. For example, each of the N data transform accelerators may be individually associated with a different number of containers. For example, a first data transform accelerator may be a 100 Gbps device and may be associated with eight containers, and a second data transform accelerator may be a 200 Gbps device and may be associated with ten containers.

A determination of the selected container may be based on a size associated with the commands to be load balanced by the host software 116. Alternatively, or additionally, the host software 116 may select a container based on a command size depth and/or a data size depth in the queue depth-based load balancing method. The command size depth may refer to a total number of commands to be processed within a particular container and/or a total number of bytes to be processed relative to the pending commands, and the data size depth may refer to a total data byte count of the commands to be processed within the particular container. Alternatively, or additionally, the total pending operations in any given container may be defined as a total number of commands pending in the container. A particular container, with index m, having a minimum amount of work pending (e.g., relative to other containers) may be selected using equation 706 of FIG. 7, where nₚ is the total number of outstanding commands in container p, M is number of containers in one data transform accelerator, and N is the total number of data transform accelerators. The available containers are enumerated as 1, 2, . . . . M*N. In instances in which there are multiple data transform accelerators and each of the multiple data transform accelerators are associated with a different number of containers, the above selection process may consider all of the containers across all of the data transform accelerators. Alternatively, or additionally, the load balancing operations may be performed independently across different data transform accelerators, where each instance of the load balancing operations may consider containers available to a particular data transform accelerator.

Alternatively, or additionally, a total pending operations estimate in a container may consider a command type of each pending command in the container, and may use one or more weights for the command type in determining the total pending operations. The weights may be decided based on a workload (e.g., latency of execution) of the command type presenting to the data transform accelerator 120. For example, a command to carry out an XP10 compression algorithm with 64 Kbytes history size may have more weight than another command to carry out an XP10 compression algorithm with 16 Kbytes history size. In another example, a command to carry out an XP10 compression algorithm with 16 Kbytes history size may have more weight than a command to carry out a chained operation of AES-CBC encryption with 192 bit key size, padding, and NVMe protection information (PI) insertion on the encrypted and padded data.

In some instances, the weights may be predetermined based on priorities established relative to the host device 110 and/or the data transform accelerator 120. For example, a read operation may have a higher priority than a write operation, as a write data transform operation may be longer than a read data transform operation. In the example, latency associated with the write data transform operation (e.g., data transform operations performed in the encode direction) may be hidden (e.g., an amount of time from the write request to the actual write data transform operation may be unknown by the requesting system), while latency associated with the read data transform operation (e.g., data transform operations performed in the decode direction) may not be hidden (e.g., an amount of time from the read request to the actual read data transform operation may be measureable by the requesting system) as there may be anticipation for the transformed data. Alternatively, or additionally, the weights may be based on one or more service level agreements that may direct particular tasks (e.g., commands, data transform operations, service groups, command groups, etc.) be performed with a determined priority. During operation of the system 100a (or the system 100b), the weights (and/or the direction of the input data based on the weights) may be adjusted, such as in view of variations to the input data (e.g., a pattern associated with the input data and/or a workload associated with the input data).

In an example, in instances in which power to the system 100b fails, the system 100b may operate on battery backup. In such instances, the read operations (e.g., decode direction traffic) which may have been high priority, may be updated to be no priority (e.g., stop operations) and the write operations (e.g., the encode direction traffic) may be allotted all the priority so as to save any unwritten data prior to the battery backup failing. In another example, priorities for normal operations may be established in view of a heavy workload by the system 100b. At a subsequent time, active traffic may decrease for the system 100b. In response, the priority traffic may be read, compare, and/or write for deduplication operations or the priority traffic may be decode and/or re-encode operations that may utilize a larger command size that may be operable to change hot data to cold data, which may improve compression ratios by the system 100b and/or may improve overall effective capacity of the system 100b. Hot data may include any data that may have been requested and/or otherwise accessed within a threshold amount of time, which threshold may be defined by an associated storage device. Alternatively, or additionally, cold data may include data that was once hot data, but the threshold amount of time may have elapsed without a request and/or access of the hot data, such that the associated storage device may updated the hot data to be cold data. The cold data may be stored in the associated storage device in a different manner relative to the hot data, such as using a more efficient compression algorithm and/or a different block size relative to the hot data.

Alternatively, or additionally, the weights may include a preassigned weight based on the commands and/or the operations associated with the commands. For example, encode operations with RTV may be weighted at a multiple of 1.6 relative to a decode operation, as encode operations with RTV may take approximately 1.6 times as long for a similarly sized decode operation.

Using the command type and associated weight, a particular container, with index m, may be selected that includes fewer pending operations relative to other containers using equation 708 of FIG. 7, where dpi is the length of the source data in the i-th command in container p, nₚ is the total number of outstanding commands in ring p, wₚᵢ is the weight of i-th command based on operations performed in the command (e.g., compression, encryption, hash, NVMe PI verification and insertion, and/or a chained operation including of one or more of the operations). In some instances, wᵢ may be selected from a set of weights without regard to the containers. In instances in which there are multiple data transform accelerators and the multiple data transform accelerators are individually associated with a different number of containers, the selection process using command type and associated weight may consider all of the containers across all of the data transform accelerators. Alternatively, or additionally, the load balancing operations may be performed independently across different data transform accelerators, where each instance of the load balancing operations may consider containers available to a particular data transform accelerator.

Alternatively, or additionally, the length of the source data in the command may not be used in the computation of the pending operations in a particular container. As such, a particular container may be selected to store a command address based on the particular container having a minimum value of a weighted sum of the commands in all considered containers. The index m of the selected container may be determined using equation 710 of FIG. 7, where wₚᵢ is the weight of i-th command based on the operation performed in the command (e.g., compression, encryption, hash, NVMe PI verification and insertion, and/or a chained operation including of one or more of the operations), nₚ is the total number of outstanding commands in container p, wₚᵢ is selected from a set of weights without consideration of the container, M is number of containers in one data transform accelerator and N is the total number of data transform accelerators. In an example, in instances where only two weights are included in the calculation, {w_{compression}, wₒₜₕₑᵣₛ}, w_{compression} may be used when a command involves a compression operation, and wₒₜₕₑᵣₛ may be used for any other commands (e.g., all commands that are not compression operations). In instances in which there are multiple data transform accelerators and each of the multiple data transform accelerators are individually associated with a different number of containers, the selection process using the weights as described may consider all of the containers across all of the data transform accelerators. Alternatively, or additionally, the load balancing operations may be performed independently across different data transform accelerators, where each instance of the load balancing operations may consider containers available to a particular data transform accelerator.

Load balancing using the CPU core ring-based method (or CPU core ring method) may include multiple command submission threads associated with the host device 110 that may submit command requests via the command submission module in the host software 116. For example, the host processor 112 may be more than one processing device (e.g., multiple CPUs) and/or the host processor 112 may include multiple cores (e.g., multiple cores per CPU), and each of the cores of the host processor 112 may be multi-threaded, where each thread (e.g., a command submission thread) may be operable to submit a command request. In some instances, the command submission threads may be operable to run concurrently on the multiple cores. In some embodiments, each command submission thread may be tied to a particular CPU core which may disable migration across the multiple CPU cores. In some instances, to reduce command submission latency and/or to improve performance of command execution, a subset of the containers from all of the containers 115 associated with all of the data transform accelerators, may be mapped to each CPU core (or a limited subset of CPU cores where the command submission threads may be operable to run). For example, the host processor 112 may have a first core, a second core, and a third core and each of the cores may be coupled with a first container associated with a first data transform accelerator, a second container associated with a second data transform accelerator, and a third container associated with a third data transform accelerator. The first core may include a first thread for submission of command requests to the first container, a second thread for submission of command requests to the second container, and so forth, for each of the first core, the second core, and the third core. Alternatively, or additionally, more than one container associated with each data transform accelerator can be coupled to each CPU core. For example, the first core may include a first thread for submission of command requests to a first container in a first data transform accelerator, and a second thread (in the first core) for submission of command requests to a second container in the first data transform accelerator. In these and other embodiments, the assignment between the cores and the containers may be done during initialization of the data transform accelerator 120 by the host device 110 or the resource management module in the host software 116.

The CPU core ring-based load balancing method may be used by the command submission module in the host software 116. Once the command submission module receives a command request, the command structure may be constructed in the host memory 114 and/or the internal memory 124. The load balancing module in the host software 116 may determine a particular CPU core of the host processor 112 executing the thread invoking the command submission module using operating system utilities/primitives. Once the particular CPU core is determined, one of the containers may be selected and may be mapped to the particular CPU core. In instances in which more than one container is mapped to the particular CPU core, then another load balancing method (e.g., round-robin load balancing method or queue depth-based load balancing method, as described herein) may be used to select a container from the subset of the containers coupled with the particular CPU core across the multiple containers.

Load balancing using the class of service method may be used in instances in which a data transform accelerator includes multiple banks of data transform engines. An example of a system 100b operable to implement the class of service method is illustrated in FIG. 1B, which may be similar to the system 100a of FIG. 1A. Some differences between the system 100b relative to the system 100a of FIG. 1A may include first data transform engines 126a, second data transform engines 126b, referred to collectively as data transform engines 126 (or multiple banks of data transform engines 126), a first direct memory access (DMA) controller 128a, a second DMA controller 128b, referred to collectively as the DMA controllers 128, a first class of service queue 130a, a second class of service queue 130b, a third class of service queue 130c, and a fourth class of service queue 130d, referred to collectively as class of service queues 130. Alternatively, or additionally, the internal memory 124 of the data transform accelerator 120 may store containers (e.g., as opposed to or in addition to the containers stored in the host memory 114 as described relative to FIG. 1A), which may include a first container 125a, a second container 125b, a third container 125c, a fourth container 125d, and a fifth container 125e, referred to collectively as containers 125.

In some embodiments, the multiple banks of data transform engines 126 may be operable to perform differing operations. For example, the first data transform engines 126a may perform data transform operations in both the encode direction and the decode direction and the second data transform engines 126b may perform data transform operations in the decode direction. In some embodiments, the data transform engines 126 may individually interface with the DMA controllers 128. For example, the first DMA controller 128a may interface with the first data transform engines 126a and the second DMA controller 128b may interface with the second data transform engines 126b. The DMA controllers 128 may be independent from one another and may be operable to control traffic (e.g., data transform operations submitted from the host device 110) to the data transform engines 126, such that the traffic in the first data transform engines 126a may not interfere with traffic in the second data transform engines 126b.

In such an arrangement, the data transform accelerator 120 may support at least two classes of service (e.g., forwarding groups) using the first data transform engines 126a and the second data transform engines 126b. The classes of service may include an assured forwarding group (e.g., a first group) and/or expedited forwarding group (e.g., second group). Assured forwarding may include assigning encode direction or decode direction data transform operations to the first group. The data transform operations assigned to the first group may be processed by the first data transform engines 126a. As a mix of encode and decode direction transform operations may be performed by the first group using the first DMA controller 128a (e.g., a single DMA channel), an encode command can do head of the line blocking to a decode command. To circumvent the blocking problem, latency-sensitive decode direction transform operations may be assigned to the second group.

The second group may facilitate decode direction transform operations, that may be processed by the second data transform engines 126b. As described in the example, only decode direction transform operations may be performed by the second group. As such, an encode command may not cause head of the line blocking for a decode command as may be the case when the first group is used.

The system 100b illustrated in FIG. 1B includes two banks of data transform engines, but more or less data transform engines may be implemented in the system 100b, which may enable additional classes of service (or forwarding groups). For example, another expedited forwarding group may be used for a power failing notification to the system 100b where the system 100b may temporarily switch to battery backup. In such an example, some lower priority commands (e.g., a write command) may be cached in memory so higher priority commands (e.g., a read command, a decode command, etc.) may be performed by the system 100b and/or some lower priority write commands that are cached may be flushed to storage. Further, in instances in which the system 100b is unable to process additional commands and/or is on a timer (e.g., due to operating using battery backup), the lower priority commands may become the commands processed by the system 100b. Alternatively, or additionally, the flushed lower priority write commands may be stored in a highest priority queue for encode direction operations. Further, with a quality of service implemented, bandwidth may be assigned to the expedited forward queues when traffic is present, and when the expedited forward queues are empty, the bandwidth may be reduced or restricted.

In some embodiments, assignment of data transform engines 126 in the first group and the second group may be hardwired in the data transform accelerator 120. Alternatively, or additionally, the assignment of the data transform engines 126 may be configurable during initialization of the data transform accelerator 120. For example, software in the host device 110 or firmware associated with the internal processor 122 (e.g., an embedded CPU) on the data transform accelerator 120 may configure the assignment of the data transform engines 126. A first set of containers 125 (e.g., the first container 125a and the second container 125b) in the internal memory 124 may be used to submit commands to the first data transform engines 126a and a second set of containers 125 (e.g., the third container 125c, the fourth container 125d, and the fifth container 125e) may be used to submit commands to the second data transform engines 126b. As described in the present disclosure, the containers 125 may be disposed in the internal memory 124 (as illustrated in FIG. 1B) and/or in the host memory 114 (as illustrated in FIG. 1A).

In some embodiments, the first data transform engines 126a and/or the second data transform engines 126b may each be associated with one or more queues operable to provide a service class associated with the data transform engines 126. As illustrated, the first data transform engines 126a may be associated with the first class of service queue 130a and the second class of service queue 130b, and the second data transform engines 126b may be associated with the third class of service queue 130c and the fourth class of service queue 130d.

The classes of service may be a strict priority queue, a weighted round robin (WRR) queue, and/or other class of service queues. Alternatively, or additionally, the class of service queues 130 may have different priority based on the implemented class of service, and each the class of service queues may be assigned a peak bandwidth limit. For example, a strict priority queue may have a higher priority than a WRR queue. In another example, a first strict priority queue may have a higher priority than a second strict priority queue, and the first strict priority queue and the second strict priority queue may be individually assigned a peak bandwidth limit. The class of service queues may be configured with a priority and a peak bandwidth limit for strict priority arbitration and/or a weight for WRR arbitration, to share the bandwidth of the associated data transform engines 126.

Commands from the command pointer rings may be fetched from these queues and processed by the transform engines using the priority of the queues. Commands in the containers 125 may be fetched from the class of service queues 130 and may processed by the associated data transform engines 126 using the priority of the class of service queues 130. In some instances, the commands may include a command tag that may be used to identify a class of service to which the command may belong. For example, the DMA controllers 128 may obtain a command tag associated with a command and the DMA controllers 128 may be operable to sort the command into one of the class of service queues 130.

Using strict priority arbitration, commands from a highest priority class of service queue may be processed by the associated data transform engines 126 first. Commands from lower priority class of service queues may be processed after all the commands from higher priority class of service queues (e.g., at least the highest priority class of service queue) have been processed, or after commands from the higher priority class of service queues have exhausted peak bandwidth limit associated with the higher priority class of service queues. For example, in instances in which the first class of service queue 130a and the second class of service queue 130b each have a waiting command and the first class of service queue 130a has a higher priority than the second class of service queue 130b, the first class of service queue 130a may be serviced until the first class of service queue 130a is empty or the peak bandwidth limit associated with the first class of service queue 130a is reached, then the second class of service queue 130b may be serviced.

Using WRR arbitration, a number of commands that may be processed in a time interval from one of the class of service queues 130 may be proportional to the weight of the queue (e.g., the higher the weight associated with the class of service queue, the more commands that may be processed from the class of service queue). In some embodiments, a WRR queue may have a lower priority than a strict priority queue, such that once the strict priority queues have individually reached their peak bandwidth limit, the arbiter may dispatch a command from one of the WRR queues, if present. In instances in which one or more of the class of service queues 130 have no commands to be processed, their bandwidth may be automatically assumed by other class of service queues 130 that include commands to be processed.

In instances in which the class of service is disabled and/or not yet established (e.g., no strict priority queues, WRR queues, etc.), the commands from all of the class of service queues 130 may be dispatched using the round-robin method across the class of service queues 130. As the class of service queues 130 are tagged with an appropriate class (e.g., strict priority or WRR) and bandwidth of the strict priority queues is assigned and/or weight of the round-robin queues as set, the classes of service in the first data transform engines 126a and/or the second data transform engines 126b may be configured.

Following the establishment of the class of service queues 130, a subset of the containers 125 may be individually mapped to the class of service queues 130, where the containers 125 may share the time slot resources assigned to the individual class of service queues 130. For example, the first container 125a mapped to the first class of service queue 130a, the second container 125b mapped to the second class of service queue 130b, the third container 125c mapped to the third class of service queue 130c, and the fourth container 125d and the fifth container 125e mapped to the fourth class of service queue 130d. In some instances, more than one data transform accelerator may be attached to the host device 110 and/or each of the attached data transform accelerators may include more than one class of service queue and/or more than one bank of data transform engines. In each class of service queue and/or in each bank of transform engines, multiple service classes may be defined and containers associated with each data transform accelerator may be mapped into the different service classes.

In some embodiments, the number of the containers 125 that may be associated with each class of service may be determined and/or established during the initialization of the data transform accelerator 120. The containers 125 may be static in relation to their association with the classes of service during operation of the data transform accelerator 120. In some instances, the containers 125 may be reconfigurable, which reconfiguration may be based on a user request or a determined need (e.g., an imbalance in the number of commands assigned to a class of service relative to the number of container assigned to the class of service). For example, the fourth container 125d may be associated with the fourth class of service queue 130d (as illustrated in FIG. 1B) upon initialization, and may be reconfigured to be associated with the third class of service queue 130c, such as based on a first workload associated with the third class of service being greater than a second workload associated with the fourth class of service.

In some embodiments, the host device 110 may be operable to perform multiple load balancing operations at various stages of the load balancing operations described herein. For example, the host device 110 may perform a first load balancing operation to select the second data transform engines 126b (as opposed to the first data transform engines 126a), a second load balancing operation to select the fourth class of service queue 130d (as opposed to the third class of service queue 130c), and a third load balancing operation to select the fourth container 125d (as opposed to the fifth container 125e). In each stage of load balancing, the host device 110 may employ one or more of the load balancing methods described herein to determine where a particular command may be distributed.

As part of initialization of the data transform accelerator 120, software in the host device 110 (e.g., a resource management module) may assign the services classes in each data transform accelerator with a priority (e.g., strict priority, WRR, or a combination of strict priority and WRR). In instances in which a service class is assigned to be a strict priority, the resource management module may configure a peak bandwidth for the strict priority queues. In instances in which a service class is assigned to be a WRR, the resource management module may configure the weight of sharing bandwidth, where the bandwidth for the WRR queue may be a residual after of the peak bandwidth configured for the strict priority queues.

After priority assignment and bandwidth allocation is complete, a set of service classes may be created, with each service class served by one of the class of service queues 130. Alternatively, or additionally, the containers 125 may be mapped to each of the class of service queues 130. For example, in an example data transform accelerator having eight queues, with different priorities between the queues, and 64 containers for each bank of data transform engines in the example data transform accelerator, a first set of eight containers may be assigned to first class of service queue, a second set of eight containers may be assigned to second class of service queue, and so forth. Alternatively, or additionally, a load balancing method for each service class container may be defined where a different load balancing method may be defined across differing set of containers that may be mapped to different service classes.

In instances in which the data transform accelerator 120 is a storage and/or cryptographic data transform accelerator, the commands that may be assigned a class of service may be grouped into one or more acceleration sessions in software running on the host device 110. An acceleration session may include a set of commands that may be provided a service class in each bank of the data transform engines 126.

For example, a user of the software on the host device 110 may create three acceleration sessions in the first data transform engines 126a—a first acceleration session using strict priority and operable to receive 50 Gbps of throughput of command execution on the data transform accelerator 120, and a second acceleration session and a third acceleration session individually using WRR having weights set to 0.6 and 0.4, respectively. In instances in which the total throughput of the command execution in the first data transform engines 126a of the data transform accelerator 120 is 100 Gbps, the first acceleration session may receive up to 50 Gbps, and the left over throughput (which may be up to 50 Gbps) may be shared between the second acceleration session and the third acceleration session in round-robin fashion with the second acceleration session receiving approximately 60% and the third acceleration session receiving approximately 40%. When the user submits a command to the command submission module, the user may specify a particular bank of data transform engines to execute the command (e.g., by specifying assured forwarding or expedited forwarding) and class of service (e.g., by specifying strict priority or WRR) in the particular bank of data transform engines.

Upon receiving the command, the command submission module may determine a particular service class and may coordinate with the load balancing module in the host device 110 to determine a particular container of the containers 125 mapped to the particular service class to which the command may be submitted.

Modifications, additions, or omissions may be made to the system 100a or the system 100b without departing from the scope of the present disclosure. For example, the designations of different elements in the manner described is meant to help explain concepts described herein and is not limiting. Further, the system 100a or the system 100b may include any number of other elements or may be implemented within other systems or contexts than those described. For example, any of the components of FIG. 1A or FIG. 1B may be divided into additional or combined into fewer components.

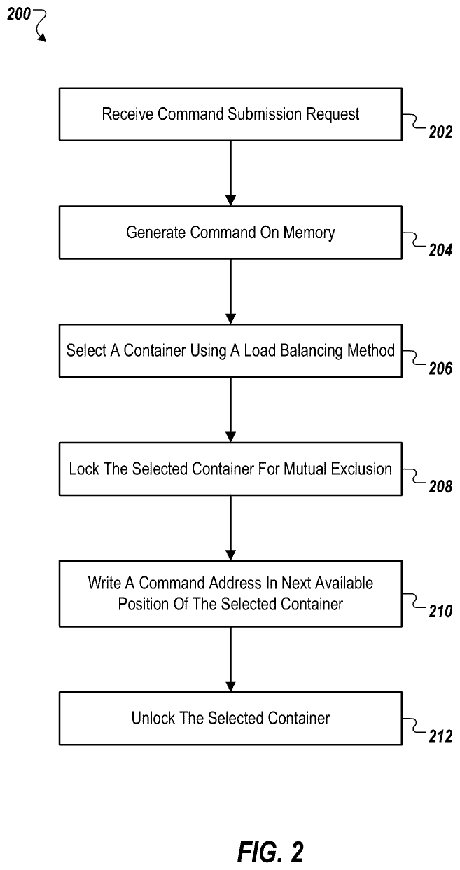

FIG. 2 illustrates a flowchart of an example method 200 of submitting a command to a container using load balancing. The method may begin at block 202 where an application in host software (e.g., the host software 116 of FIG. 1A) of a host device (e.g., the host device 110 of FIG. 1A) may submit a command request and a command submission module in the host software may receive the command request.

At block 204, the command submission module may generate a command based on the command request and may store the command in memory, such as host memory (e.g., the host memory 114 in FIG. 1A) in the host device and/or in internal memory (e.g., the internal memory 124 of FIG. 1A) on an associated data transform accelerator (e.g., the data transform accelerator 120 of FIG. 1A).

At block 206, the load balancing module in the host software may determine a particular container (e.g., the first container 115a or the second container 115b of FIG. 1A) to store a command address associated with the command and may direct the storage of the command address in the particular container.

At block 208, the particular container may be locked by the host software, such as by the command submission module, using a hardware lock, a software lock, and/or a hardware-software lock mechanism for mutual exclusion.

At block 210, the command submission module of the host software may write a command address in a next available position of the particular container. In instances in which the particular container is full, a next container may be selected.

At block 212, after the command address is written in the particular container, the command submission module of the host software may unlock the particular container, such that additional command addresses may be written to the particular container and/or the command addresses may be retrieved therefrom for processing the command, such as by the data transform accelerator.

Following the storage of the command address in the particular container and continuing as an example operation, the data transform accelerator may obtain the command address from the host device and may obtain the associated command stored in memory. The data transform accelerator may obtain input data (which may include various metadata), configure a data transform pipeline based on the input data, and/or perform a data transform operation to at least a portion of the input data to generate transformed data.

Subsequently, the data transform accelerator may direct the storage of the transformed data into one or more output buffers (which may be established in the command structure associated with the command). The output buffers may be disposed in the host memory, the internal memory, a combination of the host memory and the internal memory, and/or other remote storage devices, such as an NVMe storage array or a network interface card. In some embodiments, the data transform accelerator may be operable to consume a particular command and obtain an associated command address from the particular container subsequent to performing the data transform operation and generating the transformed data. In such instances, a second particular container (e.g., a results container) may be associated with the particular command and the results container may store a particular tag associated with the particular command (e.g., the results container may store tags for each completed command, which may be written by the data transform accelerator upon completion). As data transform operations associated with the particular command are completed, the data transform accelerator may notify the host device and the host device may obtain the particular tag to identify the particular command and/or the output buffer storing the results of the data transform operations associated with the particular command. For example, a tag may be stored in the results container and may include an address of a completed command. Host software on the host device may read the output buffer associated with the command by dereferencing the address from the tag and may obtain the transformed data. Upon consuming the command, the host software may reuse the space occupied by the command for a future command.

Alternatively, or additionally, the data transform accelerator may provide a notification (e.g., an interrupt and/or a flag) to the host device that the data transform operation has been performed and/or the transformed data is available in the output buffer. The host device may obtain the notification (e.g., from the interrupt and/or polling for a flag) and may access the transformed data in the output buffer. Alternatively, or additionally, the host device may transmit the transformed data to the application in the host software that generated the command request associated with the transform data.

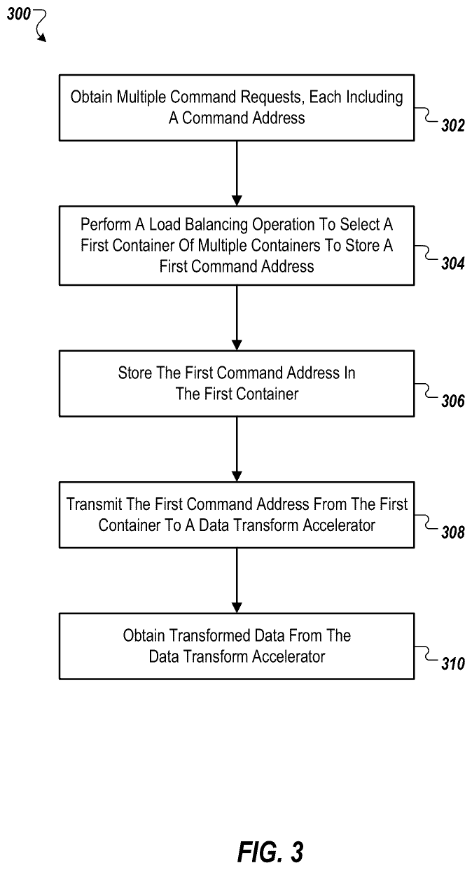

FIG. 3 illustrates a flowchart of an example method 300 of load balancing in a system including a data transform accelerator, in accordance with at least one embodiment of the present disclosure. The method 300 may be performed by processing logic that may include hardware (circuitry, dedicated logic, etc.), software (such as is run on a general purpose computer system or a dedicated machine), or a combination of both, which processing logic may be included in any computer system or device such as the host device 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 302, multiple command requests may be obtained. Each of the command requests may include a command address. The multiple command requests may be generated by one or more software applications. The software applications may include one or more threads and each thread may be operable to generate a command request of the multiple command requests.

At block 304, a load balancing operation may be performed to select a first container of multiple containers. The load balancing may be performed to scale a number of the multiple command addresses transmitted to the data transform accelerator up to a bandwidth limit associated with the data transform accelerator. Alternatively, or additionally, the load balancing may be performed using one or more of a round-robin method, a queue depth method, a CPU core ring method, and/or a class of service method.

In some instances, the first container may be locked for mutual exclusion prior to storing the first command address in the first container. Alternatively, or additionally, the first container may be unlocked after storing the first command address in the first container.

The multiple containers may be operable to store at least command addresses and the first container may be operable to store a first command address. In some instances, the multiple containers may be command pointer rings and may be operable to store the multiple command addresses.

The first command address may point to a first command and first input data. In some instances, the data transform accelerator may perform a data transform operation to the first input data using the first command. The first input data may include at least source data, metadata, and additional data. The additional data may include one or more of an initialization vector for encryption or decryption, message authentication code, metadata for data compression, and/or authentication data for encryption or decryption.

At block 306, the first command address may be stored in the first data container. In some instances, a first software application may store the first command address in the first data container and a second software application may store a second command address in a second data container.

At block 308, the first command address may be transmitted from the first data contained to the data transform accelerator. In some instances, a first set of containers of the multiple containers may be associated with a first data transform accelerator, such that the first set of command addresses stored in the first set of containers may be transmitted to the first data transform accelerator and may not be transmitted to a second data transform accelerator.

At block 310, the transformed data from the data transform accelerator may be obtained.

Modifications, additions, or omissions may be made to the method 300 without departing from the scope of the present disclosure. For example, in some embodiments, the first command address may be used from the first container in response to obtaining the transformed data. In another example, the designations of different elements in the manner described is meant to help explain concepts described herein and is not limiting. Further, the method 300 may include any number of other elements or may be implemented within other systems or contexts than those described.

FIG. 4 illustrates a block diagram of an example system 400 for load balancing in the system 400 including a data transform accelerator 420 and input/output (IO) virtualization, in accordance with at least one embodiment of the present disclosure. The system 400 may include a host device 410 and the data transform accelerator 420. The host device 410 may include a host processor 412, a host memory 414, and host software 416. The host memory 414 may include a first container 415a and a second container 415b, referred to collectively as the containers 415. The host software 416 may include a host operating system 440, a hypervisor 442, a first virtual machine 444a, and a second virtual machine 444b, referred to collectively as the virtual machines 444. The first virtual machine 444a may include first virtual machine software 446a and the second virtual machine 444b may include second virtual machine software 446b, where the first virtual machine software 446a and the second virtual machine software 446b may be referred to collectively as the virtual machine software 446. The data transform accelerator 420 may include an internal processor 422, an internal memory 424, and data transform engines 426.

The system 400 and/or the components of the system 400 may be the same or similar as the system 100 and/or the components of the system 100. For example, the host device 410, the host processor 412, the host memory 414, the containers 415, the host software 416, the data transform accelerator 420, the internal processor 422, the internal memory 424, and the data transform engines 426 may be the same or similar as the host device 110, the host processor 112, the host memory 114, the containers 115, the host software 116, the data transform accelerator 120, the internal processor 122, the internal memory 124, and the data transform engines 126 of FIG. 1, respectively. Alternatively, or additionally, the system 400 and/or the components of the system 400 may be operable to perform the same or similar operations of the system 100 and/or the components of the system 100, as described herein.

In some instances, the system 400 may be the same as the system 100 and may include support for IO virtualization, as described herein. In some instances, the hypervisor 442 may be operable to manage the virtual machines 444 on the host device 410. The hypervisor 442 may be software, firmware, and/or hardware included in the host device 410 to create and/or run the virtual machines 444. The virtual machine software 446 maybe operable to perform operations relative to the host device 410 (e.g., relative to the containers 415) and/or relative to the data transform accelerator 420. As such, the virtual machines 444 may be operable to communicate at least with the host device 410. For example, data may be transferred between the virtual machines 444 and the host device 410, load balancing may be performed by the virtual machine software 446, and/or commands and/or command addresses may be submitted from the virtual machines 444 to the data transform accelerator 420 (e.g., such as via the host device 410 and/or the host software 416). In another example, data in a buffer (e.g., an output buffer operable to store an output from the data transform accelerator 420) may be accessible by the host device 410 and/or the virtual machines 444.

In some instances, the data transform accelerator 420 may be used with a host device 410 that may include IO virtualization (e.g., single root IO virtualization). Each instance of the virtual machines 444 may be operable to communicate with the data transform accelerator 420 via the host device 410 (e.g., such as the virtual machine software 446 in communication with the host software 416) such that the virtual machines 444 may utilize the data transform accelerator 420 to perform data transform acceleration operations. In some embodiments, the containers 415 may be divided into multiple sets, where each set of the containers 415 may be associated with a data transform accelerator (e.g., such as the data transform accelerator 420) and/or with a bank of the data transform engines 426 operated by the data transform accelerators. For example, the first container 415a may be associated with a first bank of the data transform engines 426 and the second container 415b may be associated with a second bank of the data transform engines 426, where both the first bank and the second bank are associated with the data transform accelerator. In another example, the first container 415a may be associated with a first data transform accelerator and the second container 415b may be associated with a second data transform accelerator.

In FIG. 4, the data transform engines 426 are illustrated as a single bank, however, the data transform engines 426 may be the same or similar as the data transform engines 126 of FIG. 1B, where the data transform engines 426 may include multiple banks. Alternatively, or additionally, the containers 415 may be disposed in the host memory 414 and/or the internal memory 424, and the containers 415 may be individual containers or may be representative of multiple containers, such as a set of containers.

In some embodiments, the division of the containers 415 into multiple sets of containers may be hardwired in the data transform accelerator 420, may be configured by the host software 416, and/or may be configured firmware on an embedded CPU (e.g., the internal processor 422, that may be in coordination with the host software 416) in the data transform accelerator 420, such as during an initialization of the system 400 and/or an initialization of the data transform accelerator 420.

Alternatively, or additionally, for each bank of the data transform engines 426, one or more classes of service may be implemented during initialization of the data transform accelerator 420 by the host software 416 and/or by firmware in the internal processor 422. The classes of service may be the same or similar as the classes of service described relative to the system 100b of FIG. 1B that may not include IO virtualization, as described relative to FIG. 4.

In response to the classes of service being set up, which may include establishing a class therein such as strict priority, WRR, etc. as described herein, a peak bandwidth of the classes (e.g., for strict priority classes) and/or weight to share the bandwidth between multiple classes (e.g., for WRR classes) may be configured by the host software 416 and/or the firmware on the internal processor 422 as directed by the host software 416.

The containers 415 associated with each bank of the data transform engines 426 may be divided into different sets and each set of the container 415 may be assigned to each class of service in each bank of the data transform engines 426. In some instances, the division of the container 415 may be hardwired on the data transform accelerator 420. Alternatively, or additionally, the division of the containers 415 may be configured by the host software 416 and/or by the firmware on the internal processor 422, where the division may occur during initialization of the system 400 and/or an initialization of the data transform accelerator 420. Alternatively, or additionally, the data transform engines 426 may not include a class of service, and in response, the containers 415 associated with the data transform engines 426 may not be divided into sets, as described.

In some embodiments, the containers 415 in each class of service may be subdivided into one or more subsets, where each subset may be assigned to one virtual function of the virtual machines 444. The virtual functions may be operations performed by and/or requested by the virtual machines 444 with respect to the data transform accelerator 420 and/or operations performed by the data transform accelerator 420 (e.g., data transform operations). Each of the virtual machines 444 (e.g., the first virtual machine 444a and the second virtual machine 444b) using one or more virtual functions may obtain a subset of the containers 415 that may be mapped to a different class of service in each bank of the data transform engines 426. In some instances, the host device 410 may determine a quantity of all of the containers 415 that may be available for use with the virtual machines 444 and the host device 410 may allocate the containers 415 to the virtual machine 444 based on the number of virtual machines 444 in communication with the host device 410.

In the system 400, the host software 416 may be operable to perform the configuration of the classes of service, and/or may be operable to allocate the containers 415 between the classes of service and/or between the virtual functions performed by the virtual machines 444. Alternatively, or additionally, the host software 416 may direct firmware in the internal processor 422 to perform the configuration of the classes of service, and/or allocate the containers 415 between the classes of service. For example, in a PCIe environment, the configuration of the class of service and allocation of the containers 415 may be performed by a physical function (PF).

After the configuration of the classes of service and/or the allocation of the container 415 is complete, the containers 415 may be available to the virtual machine software 446 where commands may be submitted to the data transform accelerator 420 from the virtual machine (e.g., one of the virtual machines 444). The virtual machine software 446 in the virtual machines 444 may submit commands to the containers 415 that may be assigned to the virtual machines 444. For example, in instances in which the first container 415a is assigned to the first virtual machine 444a and the second container 415b is assigned to the second virtual machine 444b, the first virtual machine software 446a may submit commands to the first container 415a and the second virtual machine software 446b may submit commands to the second container 415b. The load balancing method, as described herein, may be set up by the virtual machine software 446 in each of the virtual machines 444.

The virtual machine software 446 running on one of the virtual machines 444 may access the containers 415 assigned to it. For example, host software running on the first virtual machine 444a may access the containers 415 assigned to the first virtual machine 444a (e.g., the first container 415a), and the second virtual machine 444b may access the containers assigned to the second virtual machine 444b (e.g., the second container 415b). Alternatively, or additionally, the load balancing methods described herein may be configured and/or operated by the virtual machine software 446 running on one of the virtual machines 444. The load balancing method established, as described herein, may be applicable to the containers 415 which are assigned to the corresponding virtual machine.

In these and other embodiments, the virtual machine software 446 in each of the virtual machines 444 may be operable to perform load balancing operations using the containers 415 that may be assigned to the virtual machines 444. For example, in instances in which the first container 415a represents multiple first containers that are assigned to the first virtual machine 444a and the second container 415b represents multiple second containers that are assigned to the second virtual machine 444b, the first virtual machine software 446a may perform load balancing operations relative to the first container 415a and the second virtual machine software 446b may perform load balancing operations relative to the second container 415b. Alternatively, or additionally, the virtual machines 444 may have limited visibility to containers in which they are not allocated. Referring to the previous example, the first virtual machine 444a (and/or the first virtual machine software 446a) may not have visibility into the second container 415b and the second virtual machine 444b (and/or the second virtual machine software 446b) may not have visibility into the first container 415a.

When a command is submitted to the data transform accelerator 420 by the virtual machine software 446, the virtual machine software 446 may perform a load balancing operation to determine a particular container of the containers 415 to which the command may be submitted. The selection by load balancing module on the virtual machine may be limited to the containers 415 that may be exposed to the particular virtual machine.

In an example, for a first bank of data transform engines (of the data transform engines 426), three classes of service may be established with a first class being a strict priority class and the second and third class being weighted round-robin (WRR) classes. Four containers (e.g., of the containers 415) may be assigned to the first class, six containers may be assigned to the second class, and six containers may be assigned to the third class. Additionally, two of the four containers assigned to the first class may be assigned to a virtual function mapped to a first virtual machine (e.g., the first virtual machine 444a), and the remaining two containers assigned to the first class may be assigned to a virtual function mapped to a second virtual machine (e.g., the second virtual machine 444b).

Three of the first six containers assigned to the second class may be assigned to the first virtual function mapped to the first virtual machine. The remaining three containers assigned to the second class may be assigned to the second virtual function mapped to the second virtual machine. Alternatively, or additionally, three of the second six containers assigned to the third class may be assigned to the first virtual function mapped to the first virtual machine. The remaining three containers assigned to the third class may be assigned to the second virtual function mapped to the second virtual machine.

For a second bank of data transform engines, three WRR classes may be created. Four containers may be assigned to a first WRR class, six containers may be assigned to a second WRR class, and six containers may be assigned to a third WRR class. Two of the four containers in the first WRR class may be assigned to a virtual function mapped to the first virtual machine. The remaining two containers in the first WRR class may be assigned to the virtual function mapped to the second virtual machine.

Three of the six containers in the second WRR class may be assigned to a virtual function mapped to the first virtual machine and the remaining three containers in the second WRR class may be assigned to a virtual function mapped to the second virtual machine. Alternatively, or additionally, three of the six containers in the third WRR class may be assigned to a virtual function mapped to the first virtual machine and the remaining three containers in the third WRR class may be assigned to a virtual function mapped to the second virtual machine.

The preceding example is provided for illustrative purposes only. In a system implementing IO virtualization, there may be more or less than two virtual machines. Alternatively, or additionally, there may be more or less containers and/or more or less banks of data transform engines. Further, the number of containers that may be associated with the virtual machines may be more or less than described. In some instances, the containers may be disposed in memory of the host device 410 and/or in the data transform accelerator 420.

Modifications, additions, or omissions may be made to the system 400 without departing from the scope of the present disclosure. For example, the designations of different elements in the manner described is meant to help explain concepts described herein and is not limiting. Further, the system 400 may include any number of other elements or may be implemented within other systems or contexts than those described. For example, any of the components of FIG. 4 may be divided into additional or combined into fewer components.

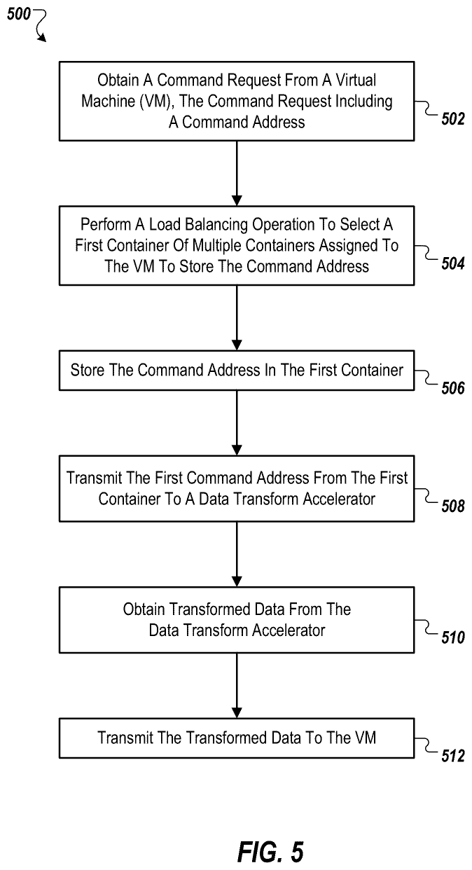

FIG. 5 illustrates a flowchart of an example method 500 of load balancing in a system including a data transform accelerator, in accordance with at least one embodiment of the present disclosure. The method 500 may be performed by processing logic that may include hardware (circuitry, dedicated logic, etc.), software (such as is run on a general purpose computer system or a dedicated machine), or a combination of both, which processing logic may be included in any computer system or device such as the host device 410 of FIG. 4.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 502, a command request may be obtained from a virtual machine. The command request may include a command address. In some instances, the command address may point to a first command and first input data. The first input data may include source data, metadata, and/or additional data. The additional data may include one or more of an initialization vector for encryption or decryption, message authentication code, and/or authentication data for encryption or decryption.

At block 504, a load balancing operation may be performed to select a first container of multiple containers assigned to the virtual machine. Based on the load balancing operation, a determination as to which of the multiple containers (e.g., the first container) may be made to store the command address. The load balancing may be performed using at least one of a round-robin method, a queue depth method, a CPU core ring method, and/or a class of service method.

In some instances, a first subset of the multiple containers may be associated with a first class of service that may be assigned to the virtual machine. Alternatively, or additionally, a second subset of the multiple containers may be associated with a second class of service that may be assigned to the virtual machine.

At block 506, the command address may be stored in the first container. The first container may be locked for mutual exclusion prior to storing the command address in the first container. Alternatively, or additionally, the first container may be unlocked after storing the command address in the first container. In some instances, the first container may implement a lock-free mechanism, such that the first container may be accessible during the storing of the command address therein. Alternatively, or additionally, the first container may be automatically configured or reconfigured between implementing a locking mechanism and implementing a lock-free mechanism.

At block 508, the first command address may be transmitted from the first container to a data transform accelerator. In some instances, the data transform accelerator may perform a data transform operation to the first input data using the first command. The load balancing described herein may be performed to scale a number of command addresses transmitted to the data transform accelerator up to a bandwidth limit associated with the data transform accelerator.

In some instances, a first set of containers of the multiple containers may be associated with a first data transform accelerator, such that a first set of command addresses stored in the first set of containers may be transmitted to the first data transform accelerator and may not be transmitted to a second data transform accelerator.

At block 510, transformed data may be obtained from the data transform accelerator.

At block 512, access to the transformed data may be facilitated by the virtual machine. For example, the transformed data may be disposed in one or more output buffers that may be accessed by the virtual machine, such that the virtual machine may obtain the transformed data from the output buffers.

Modifications, additions, or omissions may be made to the method 500 without departing from the scope of the present disclosure. For example, in some embodiments, the command address may be removed from the first container in response to obtaining the transformed data.

In another example, a second command request may be obtained from a second virtual machine. The second command request may include a second command address. A second load balancing operation may be performed to select a second container of second multiple containers that may be assigned to the second virtual machine. The second command address may be stored in the second container. In some instances, the multiple containers may be associated with a first bank of data transform engines in a data transform accelerator and the second multiple containers may be associated with a second bank of data transform engines in the data transform accelerator.

In another example, the designations of different elements in the manner described is meant to help explain concepts described herein and is not limiting. Further, the method 500 may include any number of other elements or may be implemented within other systems or contexts than those described.

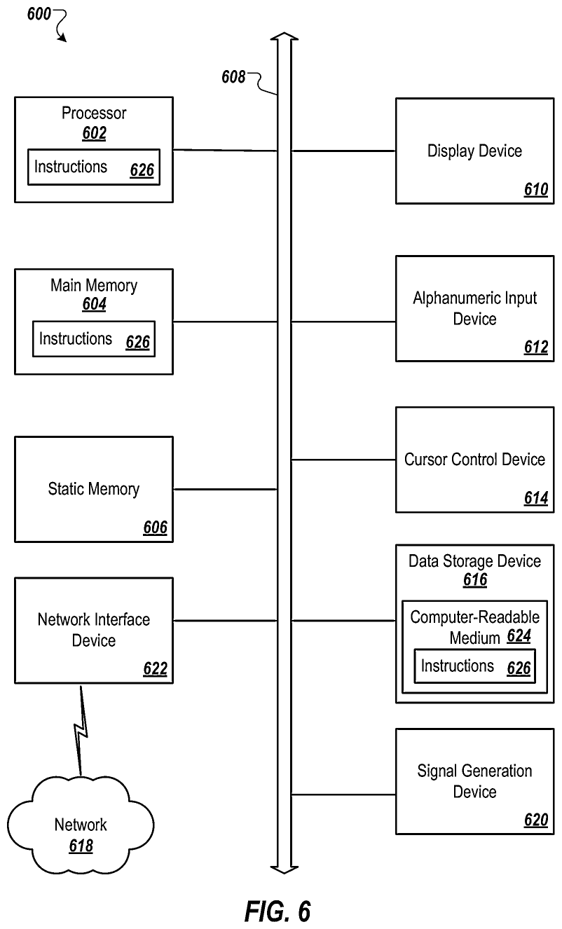

FIG. 6 illustrates an example computing device 600 within which a set of instructions, for causing the machine to perform any one or more of the methods discussed herein, may be executed. The computing device 600 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 600 includes a processing device 602 (e.g., a processor), a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

The processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one implementation, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining a plurality of command requests, each comprising a command address of a plurality of command addresses;
performing a load balancing operation to select a first container of a plurality of containers to store a first command address;
storing the first command address in the first container;
transmitting the first command address from the first container to a data transform accelerator; and
obtaining transformed data from the data transform accelerator.

2. The method of claim 1, further comprising in response to obtaining the transformed data, removing the first command address from the first container.

3. The method of claim 1, wherein the plurality of command requests are generated by one or more software applications, and wherein each software application comprises one or more threads, each thread operable to generate a command request of the plurality of command requests.

4. The method of claim 1, wherein the first command address points to a first command and first input data, and wherein the data transform accelerator performs a data transform operation to the first input data using the first command.

5. The method of claim 4, wherein the first input data comprises source data, metadata, and additional data, the additional data comprising one or more of an initialization vector for encryption or decryption, method authentication code, and authentication data for encryption or decryption.

6. The method of claim 1, wherein the plurality of containers are command pointer rings to store the plurality of command addresses.

7. The method of claim 1, wherein a first software application stores the first command address in the first container and a second software application stores a second command address in a second container.

8. The method of claim 1, wherein the load balancing is performed to scale a number of the plurality of command addresses transmitted to the data transform accelerator up to a bandwidth limit associated with the data transform accelerator.

9. The method of claim 1, wherein the load balancing is performed according to a class of service, and the load balancing uses at least one of a round-robin method, a queue depth method, or a CPU core ring method.

10. The method of claim 1, wherein the first container is locked for mutual exclusion prior to storing the first command address in the first container, and the first container is unlocked after storing the first command address in the first container.

11. The method of claim 1, wherein a first set of containers of the plurality of containers is associated with a first data transform accelerator, such that a first set of command addresses stored in the first set of containers are transmitted to the first data transform accelerator and are not transmitted to a second data transform accelerator.

12. A system, comprising:
a host device, comprising:
one or more processors; and
host software, operated by the one or more processors, to:
generate a plurality of command requests, each comprising a plurality of command addresses;
perform a load balancing operation to select a first container of a plurality of containers to store a first command address of the plurality of command addresses;
direct the first command address to be stored in the first container; and
transmit the first command address from the first container; and
at least one data transform accelerator to:
obtain the first command address transmitted from the first container; and
transmit transformed data to the host device.

13. The system of claim 12, wherein in response to transmitting the transformed data to the host device the at least one data transform accelerator, the at least one data transform accelerator further to consume the first command address from the first container.

14. The system of claim 12, wherein the load balancing is performed according to a class of service, and the load balancing uses one of a round-robin method, a queue depth method, or a CPU core ring method.

15. The system of claim 12, wherein the at least one data transform accelerator is further to:
obtain a first command associated with the plurality of command requests and first input data using the first command address; and
perform a data transform operation to the first input data using the first command to generate transformed data.

16. The system of claim 15, wherein the first input data comprises source data, metadata, and additional data, the additional data comprising one or more of an initialization vector for encryption or decryption, method authentication code, and authentication data for encryption or decryption.

17. The system of claim 12, wherein the one or more processors individually comprise one or more cores and one or more threads per the one or more cores, and wherein each of the one or more threads are operable to generate a command request of the plurality of command requests.

18. The system of claim 17, wherein a first thread of the one or more processors directs the first command address to be stored in a first container and a second thread of the one or more processors directs a second command address to be stored in a second container.

19. The system of claim 12, wherein the first container is locked for mutual exclusion prior to storing the first command address in the first container, and the first container is unlocked after storing the first command address in the first container.

20. The system of claim 12, wherein transmitting the transformed data to the host device comprises outputting the transform data into one or more output buffers accessible by the host device.
